(19) United States
(12) Patent Application Publication
(10) Pub. No.: US 2013/0194171 A1
(43) Pub. Date: Aug. 1, 2013

(54) Apparatus and Method for Mapping User-Supplied Data Sets to Reference Data Sets in a Variable Data Campaign

(71) Applicants: Kirk J. Ocke, Ontario, NY (US); Reuven J. Sherwin, Ra'anana (IL); Ranen Goren, Closter, NJ (US); Dale Ellen Gaucas, Penfield, NY (US); Michael David Shephered, Ontario, NY (US)

(72) Inventors: Kirk J. Ocke, Ontario, NY (US); Reuven J. Sherwin, Ra'anana (IL); Ranen Goren, Closter, NJ (US); Dale Ellen Gaucas, Penfield, NY (US); Michael David Shephered, Ontario, NY (US)

(73) Assignee: Xerox Corporation, Norwalk, CT (US)

(21) Appl. No.: 13/360,190

(22) Filed: Jan. 27, 2012

(51) Int. Cl. G09G 5/00

(52) U.S. Cl. 345/156

(57) ABSTRACT

In accordance with one aspect of the present disclosure, apparatus are provided that allow for the automatic categorization of the subsets of a user-supplied data set, for example recipient lists for a multivariable distribution campaign. A user interface is disclosed that facilitates the uploading of the user's recipient list. A categorizer is disclosed which categorizes subsets of the user-supplied data. A storage mechanism is disclosed which stores reference categories of data expected by the multi-variable campaign logic. A mapper is disclosed which maps the user supplied data categorized by the categorizer to the reference categories stored by the storage mechanism.

### COPYRIGHT NOTICE

This patent document contains information subject to copyright protection. The copyright owner has no objection to the facsimile reproduction by anyone of the patent document or the patent, as it appears in the US Patent and Trademark Office files or records, but otherwise reserves all copyright rights whatsoever.

### FIELD OF THE DISCLOSURE

Aspects of the present disclosure relate to tools for categorizing and automatically mapping user-supplied recipient list data sets to stored reference data set categories for the creation of a variable data campaign.

### BACKGROUND

Variable data campaign web storefronts offer a way to order pre-defined variable data campaign products, such as mailings, flyers, postcards, electronic mail blasts, and the like. These variable data campaign storefronts provide customers with the ability to supply their own unique recipient lists and select variable content to be included in the distribution to each recipient. With such products, the variable data logic for the campaign, such as the categories of recipient data, is already defined and depends on specific column names with specific types of data being present in the recipient list (e.g., a column called “f_name” that contains first names). Such products require the customer to provide a recipient list with the category names matching the category names in the variable data logic of the campaign, and which hold the same type of data as the variable data campaign logic. If the user-supplied data category names do not match the category names in the variable data logic of the campaign, the customer must manually map the customer's category names to those expected by the variable data logic. For example, if the variable data logic has a category column labeled “f_name” which corresponds to first names, while the user submits a recipient list wherein the recipient first names are listed in a column labeled “first”, the customer must manually map the “first” column in the supplied recipient list to the “f_name” category in the variable data logic of the campaign.

XMPie uStore is an example of a variable data campaign web storefront that offers a way to order pre-defined variable data campaign products while at the same time providing the customer with the ability to supply his or her own unique recipient list. XMPie uStore is a print on demand system in which variable data campaigns available for order on the storefront are already defined. The variable data logic that describes how to use the data from the recipient list to create variable content is also already defined, and depends on specific column names being present in the recipient list that contain a specific type of data. For example, the variable data logic defined in the campaign may require a column called “f_name” that contains first names be present in the recipient list. The XMPie uStore customer usage model depends on the customer providing a recipient list with the same column names as those expected by the variable data logic; otherwise the customer must manually map his or her column names to the appropriate campaign logic column names.

### SUMMARY

In accordance with one aspect of the present disclosure, apparatus are provided that allow for the automatic categorization of the subsets of a user-supplied data set, for example recipient lists for a multivariable distribution campaign. A user interface is disclosed that facilitates the uploading of the user's recipient list. A categorizer is disclosed which categorizes subsets of the user-supplied data. A storage mechanism is disclosed which stores reference categories of data expected by the multi-variable campaign logic. A mapper is disclosed which maps the user supplied data categorized by the categorizer to the reference categories stored by the storage mechanism.

### BRIEF DESCRIPTION OF THE DRAWINGS

Embodiments of the disclosure are further described in the detailed description which follows, and by reference to the noted drawings, in which like reference numerals represents similar parts throughout the several views of the drawings, and wherein:

FIG. 1 is a block diagram displaying one embodiment of an apparatus for assembling a variable data campaign including automatic categorization of user-supplied data and mapping of user-supplied data categories to expected data categories.

FIG. 2 is a flowchart of a process for mapping of user-supplied data categories to expected data categories.

FIG. 3 displays the code for a Decision Tree (listing 1) and an isClassification (listing 2).

### DETAILED DESCRIPTION

Aspects of the disclosure are directed to an apparatus and method to allow automatic mapping of a user-supplied data set with the data expected by a variable data campaign preparation program.

The present process of mapping the customer-supplied recipient data to the pre-defined variable data logic is a purely manual process that can be cumbersome, error prone and time consuming. For example, when a customer is using XMPie uStore to create a variable data campaign distribution, such as a mailing, if the user's data is not organized into columns with column names that exactly match the column names required by the XMPie uStore variable data logic, then the customer must manually map the customer's data to the variable data logic. For example, if the variable data logic requires a column named “f_names”, the customer must know that this column represents “First Names” in order to map it to the appropriate column in his or her recipient list. Therefore, uStore depends on the use of column names in the internal variable data logic which are readily understandable by customers. Also, such a manual mapping procedure is prone to human error.

Additionally, when the customer makes a mistake while manually mapping column names from his or her recipient list to what is required by the variable data logic, such mistakes are only detected by manually proofing the campaign and hoping that visual inspection catches the error.

A way to reliably automate the mapping of a customer-supplied recipient list to the variable logic when the column names do not match is desirable. Further, it is desirable to provide feedback to the customer during the mapping process based on the actual contents of the columns, such as a warning when a manually mapped column does not have the appropriate category of data that is required by the variable data logic.

Aspects of the present disclosure are based, in part, on the premise that, by assigning a semantic category associated with each recipient list data subset required by the variable data logic, and by similarly semantically categorizing the data subsets of a customer-supplied recipient list, the customer-supplied recipient list data subsets can be automatically mapped to those expected in the underlying variable data logic.

In order to automate the mapping of customer-supplied recipient list subsets to those required by the variable data logic, embodiments employ a Word List Categorizer that examines a list of words (a.k.a. a “bag of words”) and determines what semantic category they represent. For example, given a set of words such as {“Kirk”, “Mike”, “Dale”, “Reuven”, “Ranen”} the categorizer processes the list and determines that the list represents “First Names.” Additional details about the Word List Categorizer can be found below.

An aspect of the present disclosure includes an apparatus comprising: 1) an interface for ordering previously defined variable data campaign products that allows a customer to supply a recipient list; 2) a Word List Categorizer; 3) a storage mechanism, or a persistent storage mechanism, for saving and recalling what categories are associated with the variable data logic for a given variable data campaign product; 4) a mapper; and 5) an administration interface component.

In accordance with one aspect of the present disclosure, apparatus are provided that allow for (1) the automatic categorization of the subsets of a user-supplied data set (for example columns in a spreadsheet) based on the semantics of the content of the user-supplied data subsets, and (2) the automatic mapping of the user-supplied data subsets to the expected reference categories in the underlying variable data logic of a variable data campaign preparation program. The automatic categorization and mapping reduces the time and complexity of mapping user-supplied data to the data schema required by a variable data web storefront. Such automatic mapping improves the user experience by eliminating the user's need to understand the recipient list schema required by a variable data interface, such as a web storefront. This disclosure improves any variable data marketplace web storefront, as well as other applications that require mapping user-supplied data to a specific schema.

One aspect of the present disclosure allows for the automatic mapping of a customer-supplied recipient list to the campaign logic when the subset, e.g., column, names in the user-supplied recipient list do not match the categories in the variable data logic of the campaign. In other embodiments of the present disclosure, if the automatic mapping fails, manual mapping proceeds and the customer is provided feedback during the manual mapping process, such as a warning when a manually mapped column does not contain a type of data expected by the variable data logic.

In one aspect of the present disclosure, when a variable data campaign is ordered from a variable data campaign web storefront, the customer-supplied recipient list is processed by a word list categorizer that determines categories represented by each subset of data based on the semantics of the contents of each subset of data, for example a column, in the recipient list (e.g., “_fn” is First Names, “_ln” is Last Names, . . . ), this information is then compared to what is expected by the campaign logic (e.g., the campaign logic requires a column called “first” that contains “First Names”) and the recipient list is then automatically mapped to campaign logic (e.g., “_fn” is mapped to “first”). Further, in another aspect of the present disclosure, when a customer manually maps the columns in their recipient list to the expected columns in the campaign logic, a validation step can be performed, e.g., if the customer maps “_ln” to “First,” then a warning can be created when it is detected that “_ln” contains “Last Names,” but “first” is expected to be “First Names.” This idea is applicable to data sources other than just recipient lists and can be applied to other applications that depend on mapping the contents of a data source to specific semantic elements.

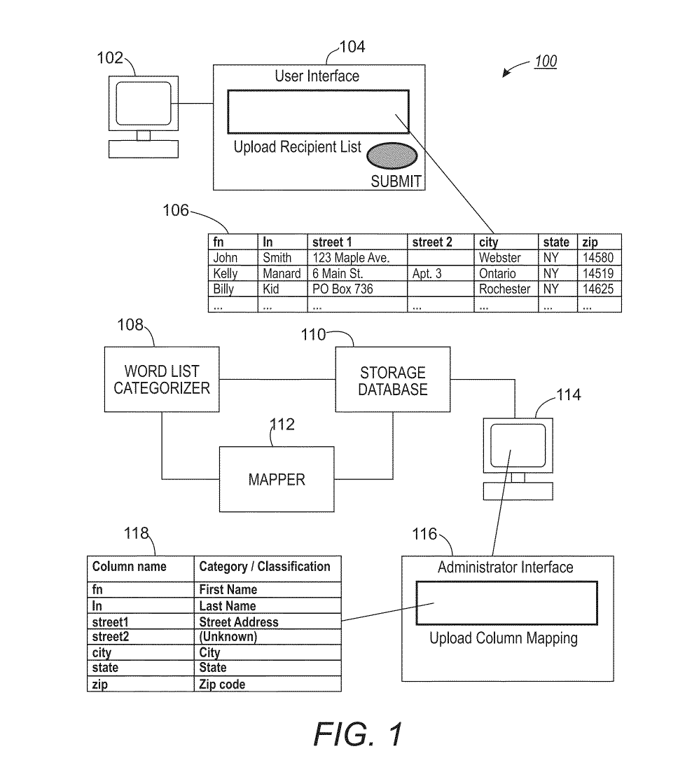

Referring now to the drawings in greater detail, FIG. 1 shows a block diagram displaying one embodiment of an apparatus 100 for assembling a variable data campaign including automatic categorization of user-supplied data and mapping categories of user-supplied data to expected data categories.

A computer interface 102 presents a user interface 104 to the user which is configured to receive a user data 106. The user data as shown in the block diagram is a recipient list containing contact information for recipients of a mailing. Such mailing contact information can be incorporated into a variable data campaign mail distribution of pre-defined variable data campaign products. The depicted user-supplied data list 106 is an exemplary embodiment. Other embodiments would include, for example, recipient electronic mail addresses for distribution of variable data campaign product via electronic mail, recipient text message contact information for distribution of variable data campaign products via text message, and social media address information for distribution of variable data campaign products across social media. In embodiments, the user-supplied recipient list 106 includes file data that can be incorporated into a print or electronic variable data campaign distribution, including text file data, image file data, and audio/visual file data such as video.

In embodiments, the computer interfaces, 102 and 114, can be the same computer, on the same computer, or part of the same computer. In embodiments, the computer interfaces, 102 and 114, can alternatively be plural computers connected over a network (not shown).

The user-supplied data set may, in embodiments, be separated into subsets. The data set depicted in the diagram as shown is separated into subsets which are organized into columns where each column represents a distinct type of data. For example, the column labeled “fn” contains user-supplied first names of recipients for the variable data campaign. The data subsets could conceivably be organized, in embodiments, into rows where each row represents a distinct type of data, but the column tabbed organization depicted is most common.

The word list categorizer 108 is configured to semantically evaluate the contents of the user-supplied data set and subsets, and to label the data subsets with category labels that match the pre-determined reference categories stored in the storage mechanism 110.

In one embodiment, the Word List Categorizer can operate by semantically classifying the columns of tabular data using an efficient decision tree algorithm. Such an algorithm is described in detail in U.S. patent application Ser. No. 12/857,997, entitled “Semantic Classification of Variable Data Campaign Information” which this application hereby incorporates herein by reference in its entirety.

The semantic classification can be accomplished, in one embodiment for example, by applying an algorithm for semantically classifying individual columns of a tabular data set. In an embodiment, a random sample of rows from the data set may be used to create lists of column values for each column that is to be classified. For embodiments, the size of the random sample may be calculated such that any column that is successfully classified can be done so with approximately 99.5% confidence. A decision tree may then be used to classify each list of column values. The decision nodes of the decision tree may use myriad decision making techniques, but most commonly consist of regular expression matching and gazetteer lookups. The following is a more detailed summary of an exemplary embodiment of an algorithm for semantic classification of the contents of customer-supplied data:

Given a data set (e.g., database records or rows in a spread sheet) where the semantic classification of the columns of the user-supplied data set is unknown, an algorithm may be applied to automatically classify the columns. An exemplary embodiment of such an algorithm is presented that uses a Decision Tree, where the decision nodes consist of regular expression matching and gazetteer lookups as well as other strategies.

The decision tree used in the exemplary algorithm presented herein is constructed manually, but could be constructed using known techniques—such as, for example, Decision Tree induction—if desired or necessary.

Homogeneity Assumption:

In certain embodiments, it may be assumed that a given column of a data set has a single classification; i.e., for example, each element in a list of column values shares the same classification. This assumption is based on the observation that it is unusual to have a data set where the different values of a column represent more than one distinct class. For example, a column where some of the values represent names and other values in the same column represent phone numbers, is atypical. This assumption that there is a single class for a given column is called the Homogeneity Assumption. The Homogeneity Assumption allows for use of Boolean decision functions to decide whether or not a column value is a member of a particular class, and it also allows for consideration of only a relatively small random sample of the input data set when classifying a column. In cases where there is generally a single class for a given column (for example if the data is organized in rows, such as where all of the values in a certain row represent first names) this homogeneity assumption can be applied to rows rather than to columns. However, for simplicity of explanation, the remainder of this disclosure will proceed by applying the homogeneity assumption to the column values.

Decision Tree:

The classification algorithm, in one embodiment, uses a decision tree to determine the class of a column from a pre-determined set of classifications. This decision tree consists of decision nodes where each decision node contains an ordered set of decisions. A recursive algorithm (“decide”) is used to walk the tree based on those decisions.

In one embodiment, following from the homogeneity assumption, each decision consists of exactly one pre-determined class, a Boolean decision function (isClassification) and a branch of the decision tree to follow if the decision function evaluates to true. The isClassification decision function decides if a list of column values matches the class assigned to the decision by evaluating (“evaluate”) each value using a strategy such as regular expression matching or gazetteer lookup and comparing the results to a minimum percentage threshold that must be met in order for the column to be considered the class assigned to the decision.

In an embodiment, as each decision node of the decision tree is encountered the set of decisions for that node are evaluated in sequence and the algorithm branches when the first decision of the decision node evaluates to true. If the decision does not contain a decision node to follow but did evaluate to true, then the algorithm terminates, assigning the column the class associated with the decision.

There are different types of decisions used by the decision nodes, such as determining the data type or average number of words in the column. For each type of decision there is a different strategy used to evaluate whether or not a given datum from the list of column values matches the class associated with the decision. The most common types of evaluations for decisions involve regular expression matching and gazetteer lookups as well as counting the average number of words in each column.

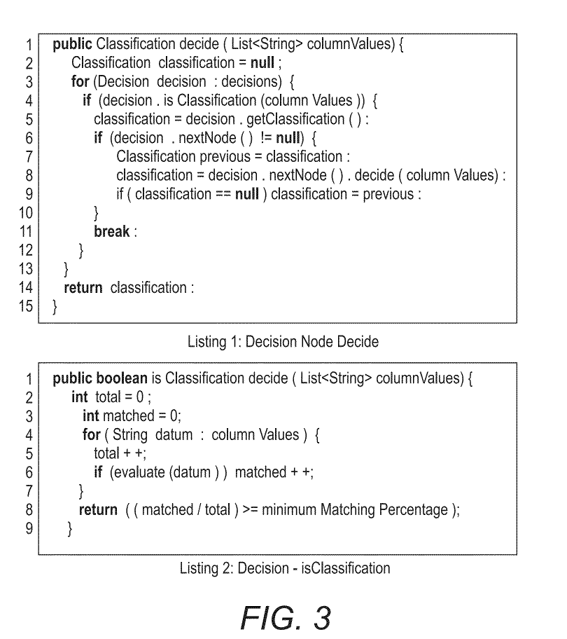

To classify a list of column values the decide algorithm (see listing 1 in FIG. 3) is called on the root node of the decision tree.

For an exemplary embodiment, the run time computational complexity of the decision tree classification algorithm will be shown to be O(1) constant time with respect to the number of rows in the data set.

Basic Algorithm Complexity:

In this section all references to computational complexity should be assumed to be with respect to run time cost unless otherwise stated. The computational complexity of walking the decision tree and then deciding when to branch using the decision functions is initially expressed as:

$${\sum }_{j = 1}^{k} ( {\sum }_{i = 1}^{n} {d}_{j} ( {v}_{i} ) ) \qquad ( 1 )$$

### Where:

k=is the number of decision functions evaluated;

n=is the number of elements in the list of column values;

dⱼ=is a decision function; and

vᵢ=is a column value.

The computational complexity of summation (1) can be simplified provided that each dⱼ executes in roughly the same amount of time T, which, as is shown below, is the case with the decision functions used in the algorithm. In such a case the complexity of summation (1) is simplified to:

O(knT) (2)

Each term in (2) is now considered starting with k, which represents the computational cost of walking the decision tree independent of the cost of decision functions. Assume that the minimum and maximum depth of reaching a terminating node in the decision tree are Depthₘᵢₙ and Depthₘₐₓ respectively. Also assume that the maximum number of decisions in any decision node in the decision tree is Decisionsₘₐₓ (Decisionsₘᵢₙ=1).

The best and worst case run time computational complexity of walking the decision tree independent of the cost of the individual decision functions is:

Best Case Time: k=Depthₘᵢₙ

Worst Case Time: k=Depthₘₐₓ×Decisionsₘₐₓ.

Since Depthₘᵢₙ, Depthₘₐₓ and Decisionsₘₐₓ are all constant values, the worst case value of k is a realtively small constant, which means it can be eliminated from (2), resulting in a run time computational complexity:

O(nT) (3)

The time required to execute a decision function is not a function of n, but instead a function of the column values (strings), and so could be eliminated from (3). However, the simplification of (1) to (3) was arrived at by assuming that each dⱼ executes in roughly the same amount of time T. So, before eliminating T from (3) consider the different types of decision functions and analyze them separately. As examples of decision functions, the three most common decision functions, namely, word counting, gazetteer lookup and regular expression matching are considered:

Word counting decision functions look for the number of occurrences of whitespace in a given column value and so the run time increases linearly with the length of the string. Since the length of the strings in a given column of a data set are usually fairly uniform the run time is effectively constant.

Gazetteer lookup decision functions uses an in memory hash table, so retrieval runs in constant time. Other gazetteer lookup methods, such as partitioning the in memory hash table and loading only portions of the gazetteer at a given time, are both more memory efficient and also can be shown to run in constant time; although with a larger constant than the in memory hash table.

Regular expression matching algorithms that use recursive backtracking run in O(2^{l}) worst case time, where l is the length of the input string. However, in embodiments, by carefully selecting (constructing) regular expressions and limiting the input size of the strings passed to the regular expression to less than 25 characters such algorithms runs in approximately linear (O(l)) worst case time. Since the length of the strings in a given column of a data set are generally uniformly distributed with a relatively small variance the run time is further reduced to what is effectively constant time. Such a restriction of string lengths to 25 or less can be easily incorporated in applications for many embodiments, including, for example, customer lists. If the commonly available recursive backtracking algorithms are not performant enough other algorithms such as Thompson NFA could be used to achieve near O(1) constant run time performance and the cost of higher space complexity. When working with regular expressions it is beneficial for each one to be empirically tested to ensure it is performant independent of the underlying algorithm.

Since each of the three types of decision function run in constant time with respect to the size of the list of column values n, the run time computational complexity (3) may be further simplified to:

O(n) (4).

The algorithm described runs in O(n) linear time with respect to the number of rows in the data set. Often, in some embodiments, linear time is not sufficient since the number of rows, n in a data set can be fairly large (n=1,000,000 is not uncommon).

Sample Size:

Since run time complexity of O(n) linear time, may be insufficient for embodiments considering large data sets, a way to reduce the computational complexity of the algorithm may be used in embodiments of the present disclosure. By using the Homogeneity Assumption we assume that each subset, e.g., column, of a data set has a single classification. Given this assumption, Boolean decision functions can be applied. The Boolean decision functions applied to column values can be a sequence of Bernoulli Trials since the trials are independent of one another.

Dealing with Bernoulli Trials, there is only a need to take a random sample of the rows in the data set to determine with a specified level of confidence whether the decision function correctly determined the classification of the values in the column. In other words, the isClassification decision function only needs to consider a random sample of the values in the column.

To achieve, in embodiments, a 99.5% confidence that the isClassification decision function was within +/−5.0% of the specified minimum percentage threshold, in embodiments the required sample size may be determined:

Assume a worst case minimum percentage threshold of 50% (p=½), then using an application of the Central Limit Theorem solve for n:

$$\begin{matrix}2.576 \sqrt{\frac{p ( p - 1 )}{n}} = 0.05 = \frac{1}{20} & ( 5 ) \\ 2.576 \sqrt{\frac{\frac{1}{2} ( \frac{1}{2} )}{n}} = \frac{1}{20} & ( 6 ) \\ 2.576 \sqrt{\frac{1}{4 n}} = \frac{1}{20} & ( 7 ) \\ \sqrt{n} = \frac{20 ( 2.576 )}{2} & ( 8 ) \\ n = {( 10 ( 2.576 ) )}^{2} & ( 9 )\end{matrix}$$

which is approximately:

n=664 (10).

This is a conservative estimate since in most embodiments the decision functions are more likely to have a minimum percentage threshold closer p= 9/10, which would results in a sample size of:

$$\begin{matrix}2.576 \sqrt{\frac{9}{100 n}} = \frac{1}{20} & ( 11 ) \\ n = \frac{{( 20 ( 2.576 ) ( 3 ) )}^{2}}{100} & ( 12 )\end{matrix}$$

which is about:

n=239. (13)

Hence the run time computational complexity with respect to the number of rows in the data source is:

O(1) (14)

if only a random sample of the column values is taken.

This is one exemplary embodiment of an algorithm that can be successfully implemented with multi variable campaign web storefront systems, such as XMPie uStore for example, to allow for automatic classification of customer-supplied recipient lists and automatic mapping of those customer-supplied recipient lists to reference categories of data expected by the variable data campaign logic.

The mapper 112 is configured to compare the categories of user-supplied data as determined by the word list categorizer 108 to the pre-determined reference categories stored in the storage mechanism 110.

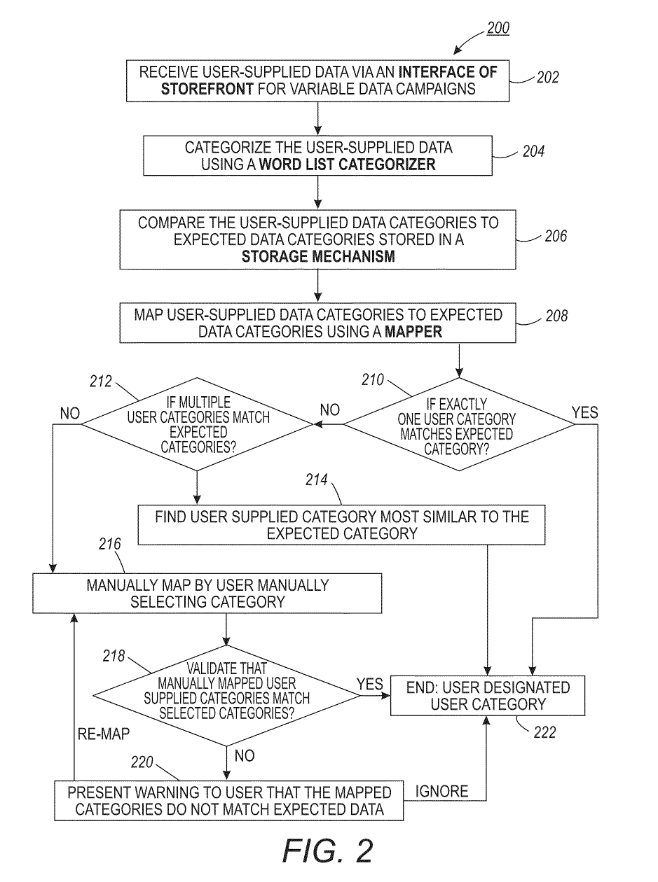

Referring in detail now to FIG. 2, a flow diagram 200 of an embodiment of a method incorporating such categorization and mapping is depicted.

A user supplied data set is received via the interface of a variable data campaign web storefront in step 202. The user supplied data may be organized into subsets, such as tab delineated columns. If only one subset exists, the data set and the subset is the same.

A Word List Categorizer categorizes the user-supplied data subsets in step 204 as described in detail above and below.

The user-supplied data subset categories are then compared to categories stored in a storage mechanism, which may in embodiments be a persistent storage mechanism in step 206.

The user-supplied data subset categories are then mapped to the reference categories stored in the storage mechanism at step 208. The mapping may be accomplished as described in detail above and below.

If, as at step 210, one user-supplied subset name matches one expected reference category name, the user-supplied subset is mapped to that category and the user-supplied subset is designated as mapping to the reference category at step 222.

If, at step 212, more than one user-supplied data subset matches an expected reference category, at step 214 the user-supplied data subset is most similar to the reference category is determined, for example, by an edit distance similarity method as described above and below, and designate that user-supplied subset as mapping to the reference category at step 222.

If the user supplied data subset does not match a single expected reference category at step 210, or multiple reference categories at step 212, the user may manually map the user-supplied data subsets to expected reference categories at step 216. Once the user manually maps the user-supplied data subsets to the expected reference categories at step 216, a validation step can be performed at step 218 to verify that the content in the manually mapped user-supplied data subsets matches the type of data expected in the reference categories. If so, the manually mapped categories are designated as mapping to the reference category at step 222.

If the content in the manually mapped user-supplied data subsets does not match the type of data expected in the reference categories, a warning is presented to the user at step 220. The user may then optionally return to step 216 to manually re-map the user-supplied data subsets, or may ignore the warning, and allow the manually mapped categories to be designated as mapping to the reference category at step 222, despite the warning.

One embodiment of the Recipient List Mapping method used to automatically map the customer-supplied recipient list columns to the recipient list columns required by the variable data logic is:

At step 204, categorize each column in a user-supplied recipient list using the Word List Categorizer. Let the results of the categorization step be denoted by the set of pairs:
U={(ucn, category) where “ucn” is a column name from the user-supplied recipient list and “category” is the result of the categorization step.}

At step 206, retrieve a list of mappings from categories to the expected column names in the variable data logic. Let the results be denoted by the set of pairs:
V={(category, vcn) where “category” is one of the categories known to the Word List Categorizer and “vcn” is the recipient list column name expected by the variable data logic.}

At step 206 and 208, for each v in V find all u in U such that the category in u matches the category in v. This is the list of potential mappings of user-supplied recipient list column names to a given column name expected by the variable data logic.
a. At step 210, if there is exactly one user-supplied recipient list column name that is mapped to the expected variable data logic column name then automatically use the user-supplied recipient list column name in the variable data logic.
b. Otherwise, as at step 212, if there exist multiple user-supplied recipient list column names that map to the same expected variable data logic column name then, as at step 214, embodiments may use an edit distance similarity metric (such as, for example, the Levenshtein metric) to choose which of the user-supplied recipient list column names to use in the variable data logic.

As at step 216, if no user-supplied recipient list column names map to the expected variable data logic column name, then, in embodiments, the user may manually map the column.

Referring again to FIG. 1, the administrator interface 116 on a computer interface 114 presents an administrator interface 118 to an administrator. The administrator can populate, via the administrator interface 118, mapping from categories to column names expected by the variable data logic as is described below.

A variation of the Recipient List Mapping method described above can be used by the variable data campaign administrator to initially populate mapping from categories to column names expected by the variable data logic. This may be done in embodiments using the proof set recipient list that was originally used when the campaign was created (the proof set is a recipient list that contains all the columns expected by the variable data logic). In this variation the proof set recipient list columns are categorized and then the category for each column is saved in the data base for future use in the Recipient List Mapping method. The administrator could also manually specify the categories for each expected column in the variable data logic in embodiments.

An exemplary Administration Mapping method for certain embodiments is:

Categorize each column in the proof set associated with the campaign using the Word List Categorizer. Let the results of the categorization step be denoted by the set of pairs:
P={(pcn, category) where “pcn” is a column name from the proof set recipient list and “category” is the result of the categorization step.}

Retrieve from the Word List Categorizer the list of all known categories. Allow the administrator the option to manually specify the mappings in P, in cases where the categorizer is either unable to categorize a column or where the categorization provided by the Word List Categorizer is incorrect.

Save the mappings P in storage, such as a persistent storage mechanism, for later use by the Recipient List Mapping method.

### Example 1

A variable data marketing campaign is created and run that consists of a post card that includes the customer's first name and address along with the picture and address of a store location based on the customer's zip code.

The original recipient list was in a form like the one below:

| fn | ln | street 1 | street 2 | cty | state | zip |
|---|---|---|---|---|---|---|
| John | Smith | 123 Maple Ave | | Webster | NY | 14580 |
| Kelly | Manard | 6 Main St. | Apt. 3 | Ontario | NY | 14519 |
| Billy | Kid | PO Box 736 | | Rochester | NY | 14625 |
| . . . | . . . | . . . | . . . | . . . | . . . | . . . |

The variable data logic for the campaign includes:

Expected Column Names: fn, zip, and other expected columns for the address not detailed in this example.

First Name Logic: display (@fn)

Store Picture Logic:
if (@zip in [14500-14519]) then
display(ontarioStore.jpg)
else if (@zip in [14520-14580]) then
display(websterStore.jpg)
else (@zip in [14581-14625]) then
display(rochesterStore.jpg)
else display(genericStore.jpg)

Store Location Logic:
if (@zip in [14500-14519]) then display(“1 Main St, Ontario N.Y., 14519”)
else if (@zip in [14520-14580]) then display(“2 Main St, Webster N.Y., 14580”)
else (@zip in [14581-14625]) then display(“3 Main St, Rochester N.Y., 14625”)
else display(“ ”)

Customer Address Logic: not detailed in this example.

The administrator of the multi-variable campaign, such as, e.g., XMPie uStore, decides to add this campaign to the web storefront. As part of adding the product to the multi-variable campaign, the administrator assigns categories to the expected column names:

The original proof set recipient list is submitted to the Word List Categorizer resulting in the following categorizations:

| Column name | Category/Classification |
|---|---|
| fn | First Name |
| ln | Last Name |
| street1 | Street Address |
| street2 | (Unknown) |
| cty | City |
| state | State |
| zip | Zip code |

The administrator at this point manually assigns street2 the category of “Street Address Line 2” since the Word List Categorizer was unable to automatically categorize it.

At a later date a customer using the multi variable campaign storefront decides to purchase the already defined marketing campaign described above. As part of this process they upload a recipient list that contains information about their specific customers:

| S1 | S2 | C | ZC | ST | Last | First |
|---|---|---|---|---|---|---|
| 3 Creek Ave | | Webster | 14580 | New York | Johnson | Andy |
| 9 Main St. | PO | Ontario | 14519 | New York | Irwin | Diane |
| | Box | | | | | |
| | 34 | | | | | |
| 78 Blossom | | Rochester | 14620 | New York | Lane | David |
| . . . | . . . | . . . | . . . | . . . | . . . | . . . |

The customer-supplied recipient list is then processed by the Word List Categorizer resulting in the following categorizations:

| Data Set Name (column name) | Category/Classification |
|---|---|
| First | First Name |
| Last | Last Name |
| S1 | Street Address |
| S2 | Street Address Line 2 |
| C | City |
| ST | State |
| ZC | Zip code |

This is then compared to the previously saved category to expected column name pairs and the following mapping automatically occurs:

Customer-supplied to expected column name mapping:
First→fn
ZC→zip
etc. (Other variables for the address not detailed in this example.)

The result is that the customer's recipient list columns are automatically mapped to the columns expected by the variable data logic; with no manual steps required by the customer.

### Example 2

A column in the original recipient list is titled “pp” and has entries that can be recognized as an enumeration, but no semantic meaning can be mapped to it (e.g., the enumeration is Republican, Democrat, Independent but the categorizer doesn't know this semantically represents a political party). If a similar column in a customer-supplied recipient list is called “party” is found and it contains the same enumeration, then the methods described maps the column “party” to the original column “pp.”

In another embodiment, the Recipient List Mapping method can be modified to use the historically most frequently occurring customer-supplied column names in cases where the Word List Categorizer fails to classify a column in a customer-supplied recipient list. Over time as the multi-variable campaign system is used and various customers provide recipient lists that are eventually mapped to the expected column names in the variable data logic (either using the method described or manually) a record is kept of the most frequently occurring customer-supplied column names that map to each expected column name in the variable data logic. When the Word List Categorizer fails to categorize a column in the customer-supplied recipient list, that column name is compared to the list of most frequently used column names and if a match is found, and the expected column in the variable data logic has not already had something mapped to it, then the column is mapped to it.

A variation of the Recipient List Mapping method, in certain embodiments, can include a warning message to the customer when it is detected that the customer has mapped a column from their recipient list to an expected column in the variable data logic, but the categories of the two do not match. For example, if the customer maps a column called “name” which contains “Last Names” to an expected column called “first name” which contains “First Names,” then a warning message about this disparity could be provided to the customer.

The Administration Mapping method can be extended to allow the administrator the option of uploading a recipient list other than the proof set recipient list. This can be useful in cases where the proof set recipient list contains an insufficient number of rows to accurately categorize the data.

### DEFINITIONS

Homogeneity Assumption: An assumption that a given column of a data set has a single classification. It assumes that all of the values in a given column are in that sense homogenous.

Class: A semantically well-defined label that can be assigned to a list of column values.

Column: An attribute of the elements in a data set.

Data Set: a collection of data that can be represented in a tabular form where each row corresponds to a given member of the collection and each column represents an attribute of the members of the collection.

Decision Function: A function ƒ→{true, false}, that maps string values to Boolean values. Decision functions are part of each decision in a decision node.

Decision Node: An interior node of a decision tree that consists of one or more decisions used to determine which branch of the decision tree to follow when a decision is made.

Decision Tree: A tree representing an algorithm where interior nodes of the tree, called decision nodes, determine which branch of the tree to take next and leaf nodes represent specific classes. A decision tree is capable of taking a list of column values as input and returning a classification.

Decision: Part of a decision node that consists of a boolean decision function and a branch of the decision tree to follow when the decision function evaluates a list of column values and returns “true.”

Row: An element of a data set, where the data set is represented in tabular form.

Terminating Node: A decision node for which all decision functions evaluate to “false.” The classification system terminates and returns when encountering such a node.

The processing performed by each of the elements shown in the figures herein may be performed by a general purpose computer, and/or by a specialized processing computer. Such processing may be performed by a single platform, by a distributed processing platform, or by separate platforms. In addition, such processing can be implemented in the form of special purpose hardware, or in the form of software being run by a general purpose computer. Any data handled in such processing or created as a result of such processing can be stored in any type of memory. By way of example, such data may be stored in a temporary memory, such as in the RAM of a given computer system or subsystems. In addition, or in the alternative, such data may be stored in longer-term storage devices, for example, magnetic discs, rewritable optical discs, and so on. For purposes of the disclosure herein, machine-readable media may comprise any form of data storage mechanism, including such memory technologies as well as hardware or circuit representations of such structures and of such data. The processes may be implemented in any machine-readable media and/or in an integrated circuit.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus comprising:
a computer interface displaying a user interface configured to receive variable data supplied by the user in at least one set, the variable data including recipient list data;
a word list categorizer configured to label as distinct categories each of the at least one user-supplied data sets based on semantics of the contents of the at least one user-supplied data sets;
a storage mechanism configured to store reference data set category names; and
a data set mapper configured to map the at least one user-supplied data set categories to the reference data set category names stored by the storage mechanism.

2. The apparatus according to claim 1 further comprising a user interface configured to allow the user to manually map the user-supplied data set categories to the reference data set category names stored by the storage mechanism.

3. The apparatus according to claim 2 wherein the data set mapper is configured to validate that the semantics of the data in the at least one user-supplied data set matches the data in the reference data set stored by the storage mechanism to which the user-supplied data sets have been manually mapped by the user.

4. The apparatus according to claim 3 wherein the user interface is configured to present a warning to the user if the semantics of the data in the user-supplied data set does not match the data in the reference data sets stored by the storage mechanism to which the user-supplied data sets have been manually mapped by the user.

5. The apparatus according to claim 1 further comprising an administrator interface configured to allow the administrator to populate mapping semantics information to reference data set category names.

6. The apparatus according to claim 5, wherein the storage mechanism is further configured to store the administrator populated mapping information.

7. The apparatus according to claim 5, further comprising an interface to allow the administrator add new reference data set categories to be stored by the storage mechanism, and to populate mapping semantics information to the new reference dataset categories.

8. The apparatus according to claim 1 wherein the column mapper is configured with an edit distance similarity metric to measure the similarity of the customer user-supplied data column names.

9. The apparatus according to claim 1 wherein the user-supplied variable data will be part of a print media distribution.

10. The apparatus according to claim 1 wherein the user-supplied variable data includes text file data.

11. The apparatus according to claim 1 wherein the user-supplied variable data includes image file data.

12. The apparatus according to claim 1 wherein the user-supplied variable data will be part of an electronic mail distribution.

13. The apparatus according to claim 12 wherein the user-supplied variable data includes video file data.

14. The apparatus according to claim 1 wherein the variable data supplied by the user is organized in tabular columns.

15. The apparatus according to claim 1 wherein the reference data sets stored by the storage mechanism are organized in tabular columns.

16. The apparatus according to claim 1 wherein the storage mechanism is a persistent storage mechanism.

17. The apparatus according to claim 1 wherein the recipient list data includes recipient contact information.

18. The apparatus according to claim 17 wherein the recipient contact information includes recipient email address information.

19. A method comprising:
receiving at least one user-supplied data set via a user interface presented on a computer interface;
labeling each of the at least one user-supplied data sets with a distinct category name;
mapping the at least one user-supplied data sets to reference data set categories stored by a storage mechanism based on the semantics of the contents of the user-supplied data sets.

20. Machine-readable media encoded with data, the data being interoperable with machine hardware to cause:
receiving at least one user-supplied data set via a user interface presented on a computer interface;
labeling each of the at least one user-supplied data sets with a distinct category name;
mapping the at least one user-supplied data sets to reference data set categories stored by a storage mechanism based on the semantics of the contents of the user-supplied data sets.
